(19) United States
(12) Patent Application Publication
(10) Pub. No.: US 2015/0328522 A1
(43) Pub. Date: Nov. 19, 2015

(54) GOLF SWING ANALYSIS APPARATUS

(71) Applicant: Q & K CO., LTD., Musashino-shi, Tokyo (JP)

(72) Inventor: Hisashi MURATA, Tokyo (JP)

(21) Appl. No.: 14/653,105

(22) PCT Filed: Dec. 17, 2013
(86) PCT No.: PCT/JP2013/084392

§ 371 Date: Jun. 17, 2015

(30) Foreign Application Priority Data
Dec. 17, 2012 (JP) 2012-274161

(51) Int. Cl. A63B 69/36; G09B 19/00

(52) U.S. Cl. CPC A63B 69/36; G09B 19/0038

(57) ABSTRACT

Provided is a golf swing analysis apparatus that enables the trajectory of the swing of an athlete or enthusiast to be artificially viewed, checked and analyzed. The golf swing analysis apparatus (1) consists of: a base plate (2); an artificial human body (3) comprising a leg part (5), a body part (6) and an arm part (7); and an artificial club (4). The upper end of the leg part (5) and the lower end of the body part (6) are rotatably linked, and the upper end of the body part (6) and the upper end of the arm part (7) are rotatably linked. The body part (6) and the arm part (7) each comprise cylinders (11, 12) so as to allow the length of each to be adjusted.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### TECHNICAL FIELD

The present invention relates to a golf swing analysis apparatus which can easily analyze a trajectory of a golf swing, be used when an athlete, an enthusiast, a teacher or the like of golf practices or teaches the golf swing, and be used when a designer, a manufacturer or the like of a golf club designs or manufactures the golf club.

### BACKGROUND ART

Conventionally, in a case where an athlete or an enthusiast practices a golf swing, or in a case where a teacher teaches the golf swing, the way of swing has been learned by viewing a golf swing performed by a model using a tutorial, a video or the like of golf.

Further, conventionally, in a case where a designer or a manufacturer of the golf club designs or manufactures the golf club, performance of a club has been checked through actual test hitting by an athlete and test hitting by a swing apparatus set with the club.

However, it takes time to master a golf swing when learning the way of swing by viewing the model's golf swing through the tutorial, video or the like of golf. Thus, recently, a swing assist apparatus which enables an athlete and an enthusiast to master a golf swing by oneself while actually taking a swing, and a teacher to teach a golf swing (see Patent Literatures 1 and 2).

### CITATION LIST

### Patent Literatures

Patent Literature 1: JP 2000-210405 A

Patent Literature 2: JP 2006-116169 A

### SUMMARY OF INVENTION

### Technical Problem

According to the swing assist apparatus described in Patent Literatures 1 and 2, although the athlete and the enthusiast can master a golf swing while actually taking the swing and the teacher can teach a golf swing, it is difficult to view and check a trajectory of the swing of the athlete and the enthusiast, which is not necessarily sufficient for learning a constant swing.

The present invention has been made in view of such a problem, and an object thereof is to provide a golf swing analysis apparatus which enables viewing, checking and analyzing a trajectory of a pseudo swing performed by an athlete or an enthusiast, which may be used when the athlete, the enthusiast, a teacher or the like practices or teaches a golf swing and be used when a designer, a manufacturer or the like of a golf club designs or manufactures the golf club.

### Solution to Problem

In order to achieve the above-described object, a golf swing analysis apparatus according to the present invention is characterized that it includes a pseudo human body having a leg part, a body part and an arm part, and a pseudo club.

Here, the leg part may be fixed to a base plate.

It is preferable that an upper end of the leg part and a lower end of the body part be rotatably connected, and an upper end of the body part and an upper end of the arm be rotatably connected.

Further, each of the body part and the arm part may be formed with a cylinder so as to enable length of each to be adjusted.

Further, the body part may be formed with a cylinder so as to enable a length thereof to be adjusted, and the arm part and the pseudo club may be connected with a telescopic rod so as to enable an angle between the arm part and the pseudo club to be adjusted.

In addition, the leg part may be formed with a lower leg part and an upper leg part.

### Advantageous Effects of Invention

According to the golf swing analysis apparatus according to the present invention, it is possible to realize each state at every time point in a trajectory of a golf swing by rotating an arm part by a predetermined angle having a body part as an axial center, and to analyze the trajectory of the golf swing by photographing each state at every time point.

### BRIEF DESCRIPTION OF DRAWINGS

FIG. 1 is a perspective view of an embodiment of a golf swing analysis apparatus according to the present invention.

FIG. 2(A) is a side view of the golf swing analysis apparatus illustrated in FIG. 1 and FIG. 2(B) is a front view thereof.

FIG. 3 is a front view which realizes a state at the time of address and the time of impact in the golf swing analysis apparatus illustrated in FIG. 1.

FIG. 4 is a front view which realizes a state at the time of backswing in the golf swing analysis apparatus illustrated in FIG. 1.

FIG. 5 is a front view which realizes a state at the time of topswing in the golf swing analysis apparatus illustrated in FIG. 1.

FIG. 6 is a front view which realizes a state at the time of downswing in the golf swing analysis apparatus illustrated in FIG. 1.

FIG. 7 is a front view which realizes a state at the time of follow-through in the golf swing analysis apparatus illustrated in FIG. 1.

FIG. 8 is a front view which realizes a state at the time of finish in the golf swing analysis apparatus illustrated in FIG. 1.

FIG. 9 is a perspective view of another embodiment of the golf swing analysis apparatus according to the present invention.

FIG. 10(A) is a side view of the golf swing analysis apparatus illustrated in FIG. 9 and FIG. 10(B) is a front view thereof.

FIG. 11 is a perspective view of further another embodiment of the golf swing analysis apparatus according to the present invention.

FIG. 12(A) is a side view of the golf swing analysis apparatus illustrated in

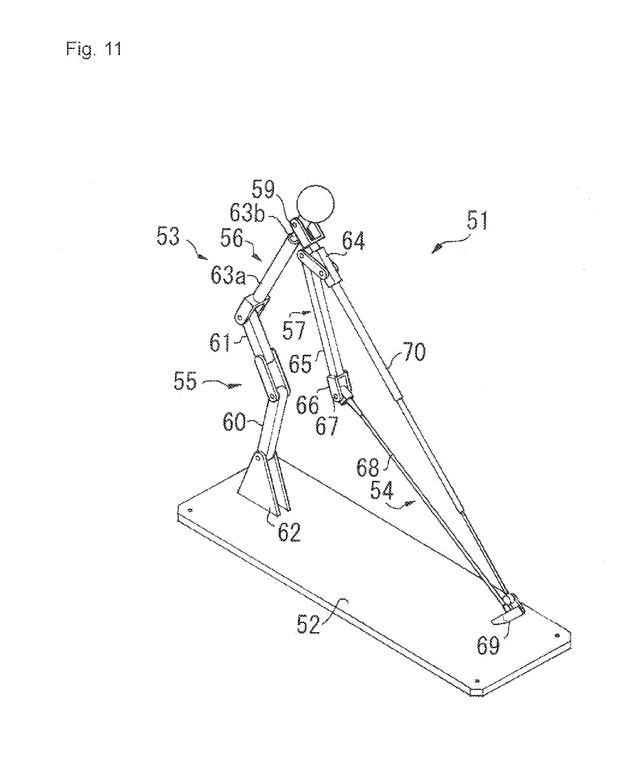

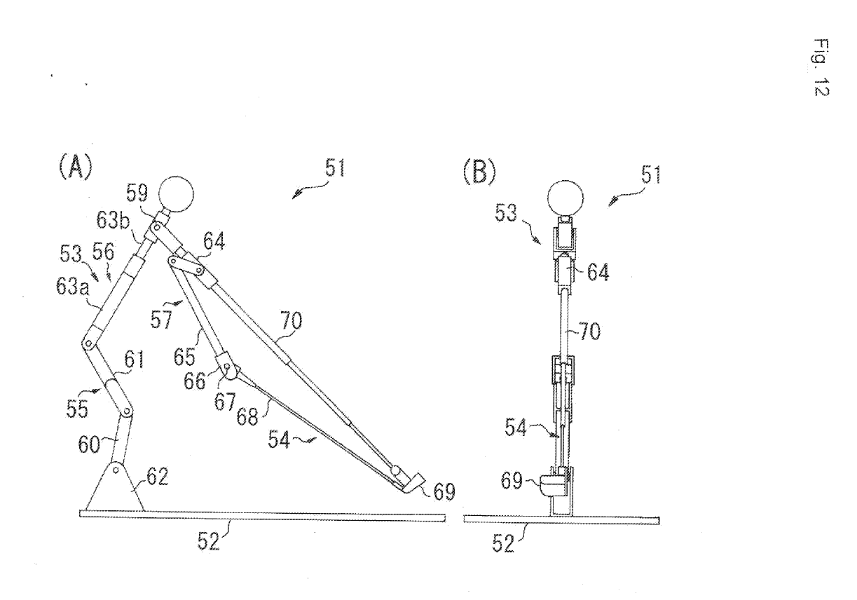

FIG. 11 and FIG. 12(B) is a front view thereof.

### DESCRIPTION OF EMBODIMENTS

Hereinafter, preferred embodiments of a golf swing analysis apparatus according to the present invention will be described in detail with reference to the drawings.

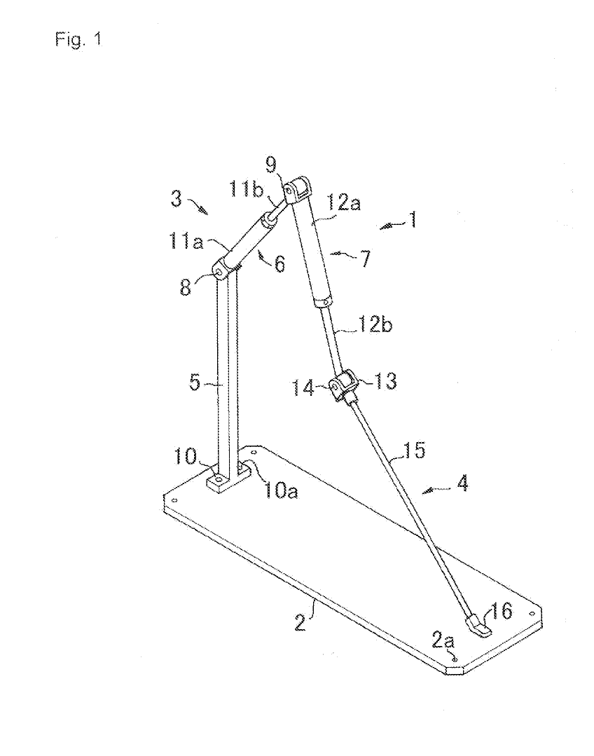

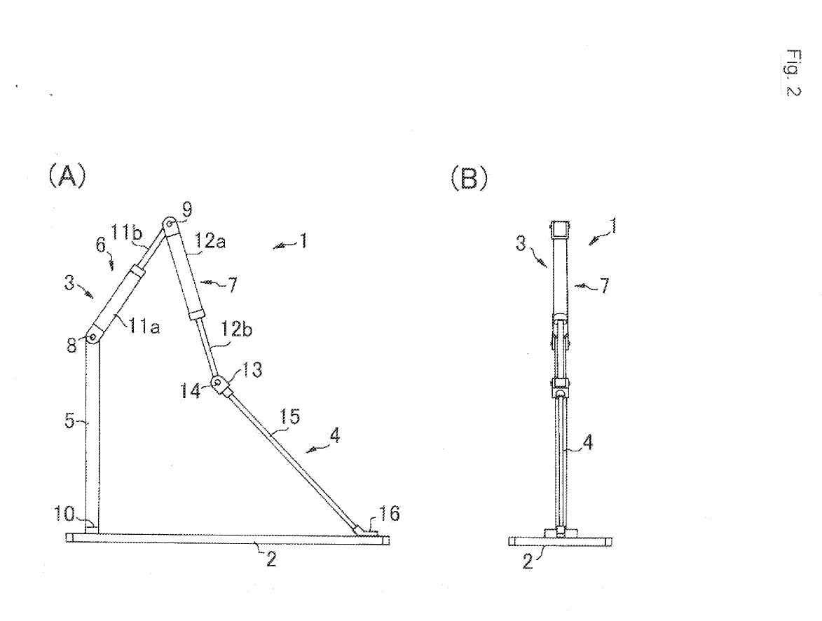

FIG. 1 is a perspective view of an embodiment of the golf swing analysis apparatus according to the present invention, FIG. 2(A) is a side view of the swing analysis apparatus and FIG. 2(B) is a front view thereof.

As illustrated in FIGS. 1, 2(A) and 2(B), a golf swing analysis apparatus 1 includes a base plate 2, a pseudo human body 3 and a pseudo club 4.

The base plate 2 is made of a thin metal plate or a synthetic resin plate, and mounting holes 2a, 2a . . . are bored in four corner parts thereof so that the analysis apparatus 1 may be fixed at a predetermined part.

The pseudo human body 3 imitates a human body and includes a leg part 5, a body part 6, and an arm part 7. Further, an upper end of the leg part 5 and a lower end of the body part 6 are rotatably connected with a support shaft 8, and an upper end of the body part 6 and an upper end of the arm part 7 are rotatably connected with a support shaft 9.

The leg part 5 is formed with a rod-like member, and a lower end thereof is connected to a foot part 10 formed with a plate-like member. Further, mounting holes 10a, 10a are bored in the foot part 10 so as to fix the base plate 2.

The body part 6 is formed with a cylinder 11, and a cylinder shaft 11b is slidable in a length direction of a cylinder rod 11a and rotatable around an axis of the cylinder rod 11a.

Accordingly, when the cylinder shaft 11b is slid and fixed at an appropriate position, a length of the body part 6 can be adjusted.

Further, when the cylinder shaft 11b is rotated, the arm part 7 may be rotated by an appropriate angle with respect to the body part 6.

In this manner, a rotating movement of an arm and a club using a body as a center axis of the swing can be realized.

Here, the arm part 7 can be regarded as a first virtual axis.

The arm part 7 is formed with a cylinder 12, and a cylinder shaft 12b is slidable in a length direction of a cylinder rod 12a and rotatable around an axis of the cylinder rod 12a.

Accordingly, when the cylinder shaft 12b is slid and fixed at an appropriate position, a length of the arm part 7 can be adjusted.

Further, when the cylinder shaft 12b is rotated, a hand part 13 can be rotated by an appropriate angle with respect to the arm part 7.

In this manner, the rotating movement of the arm and the club considering a twisting movement of the body can be realized.

Further, the U-shaped hand part 13 is rotatably connected to a lower end of the cylinder shaft 12b by a support shaft 14.

In this manner, a cocking movement of a wrist with respect to the arm can be realized.

The pseudo club 4 imitates the club and includes a shaft part 15 and a head part 16.

The golf swing analysis apparatus 1 is configured as described above. It is possible to form a usable state by fixing the leg part 5 of the pseudo human body 3 to the base plate 2, setting the body part 6 at a predetermined angle with respect to the leg part 5, setting the arm part 7 at a predetermined angle with respect to the body part 5, and fixing the shaft part 15 of the pseudo club 4 to the arm part 7.

Here, if each length of a leg part, a body part and an arm part of an athlete or an enthusiast, as a subject, and a length of the club are measured, the pseudo human body 3 can be made to correspond to the subject by sliding the cylinder shaft 11b to be fixed at the appropriate position, adjusting the length of the body part 6, sliding the cylinder shaft 12b to be fixed at the appropriate position, and adjusting the length of the arm part 7.

The golf swing analysis apparatus 1 can realize each state at every time point in a trajectory of a golf swing by rotating the arm part 7 by a predetermined angle having the body part 6 as an axial center.

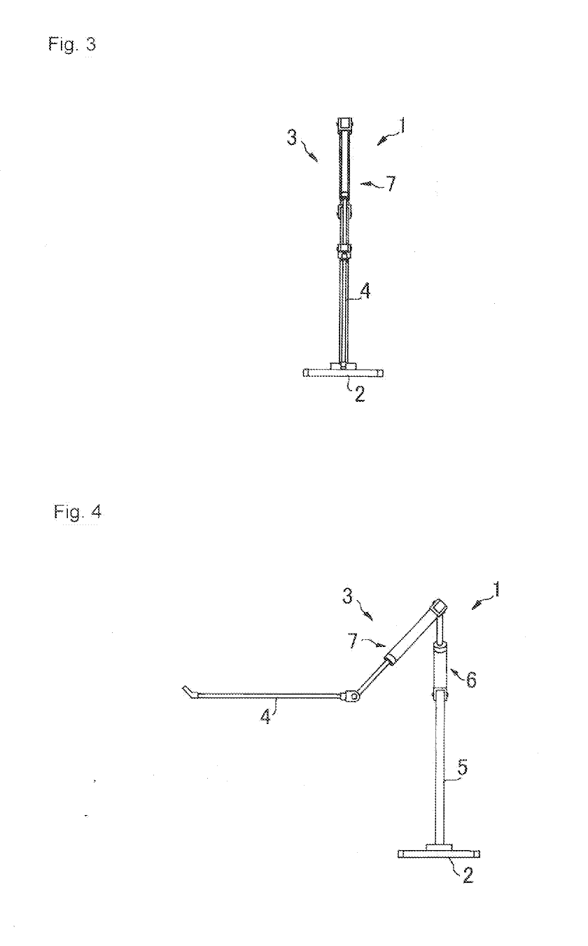

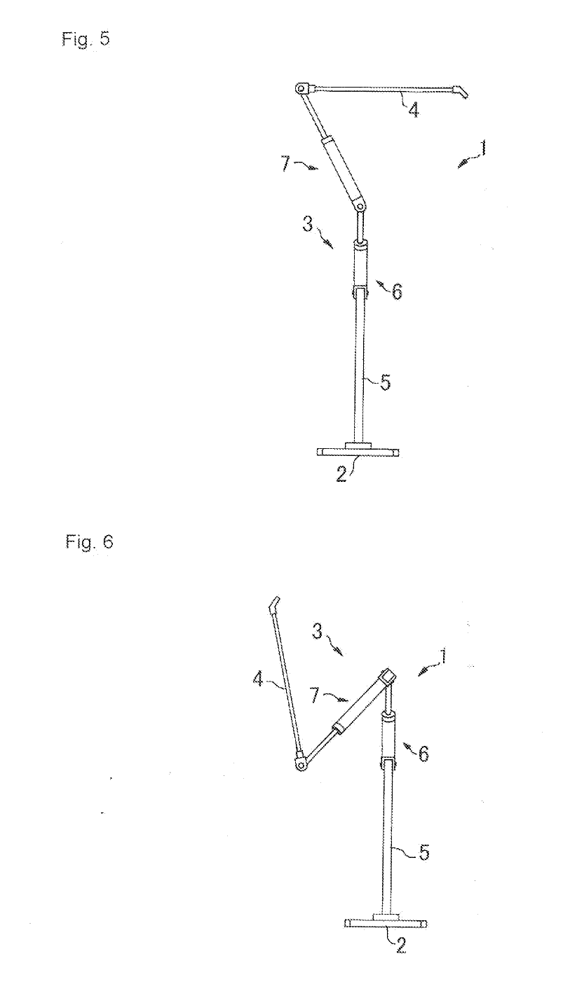

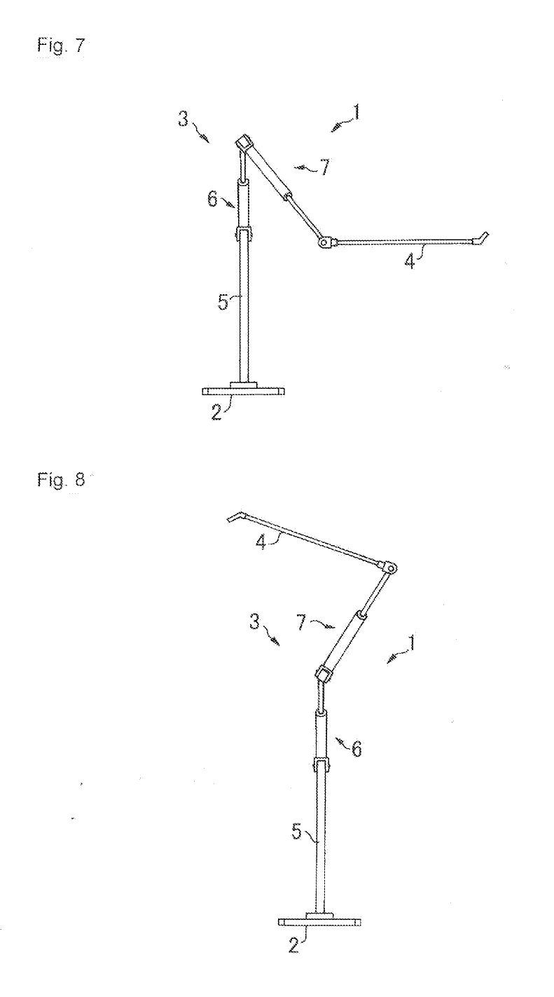

Further, as illustrated in FIGS. 3 to 8, it is possible to analyze the trajectory of the golf swing by setting a state at the time of address, a state at the time of backswing, a state at the time of top swing, a state at the time of downswing, a state at the time of impact, a state at the time of follow-through, a state at the time of finish, and the like, and photographing each state at every time point.

Next, another embodiment of the golf swing analysis apparatus according to the present invention will be described in detail with reference to the drawings.

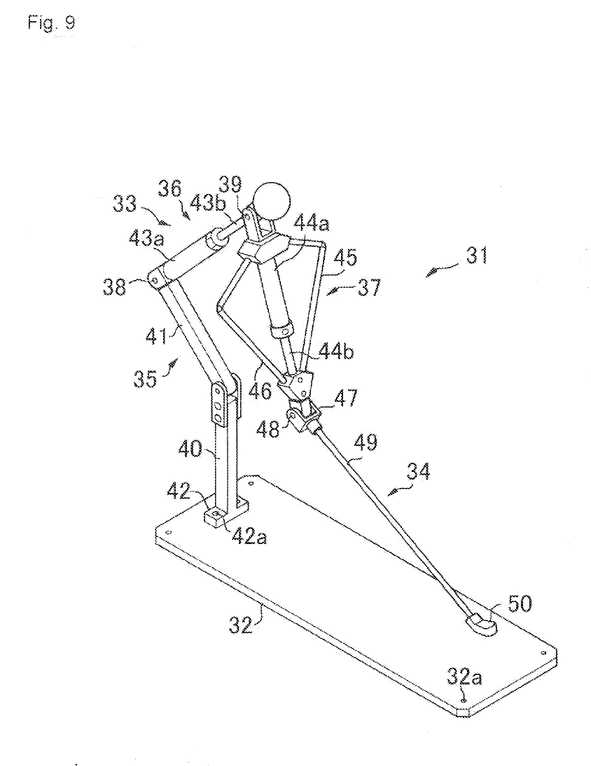

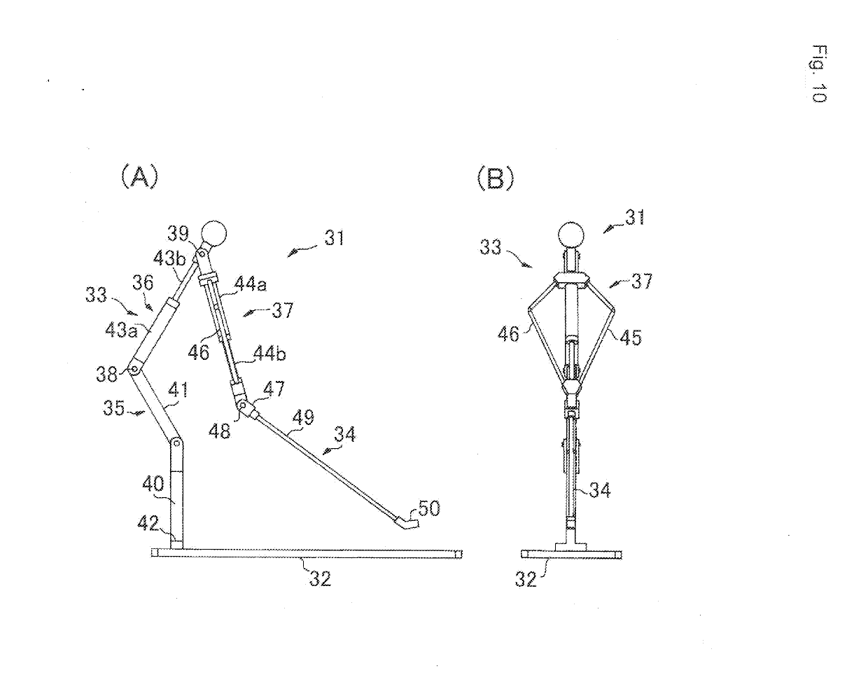

FIG. 9 is a perspective view of another embodiment of the golf swing analysis apparatus according to the present invention, FIG. 10(A) is a side view of the swing analysis apparatus, and FIG. 10(B) is a front view thereof.

As illustrated in FIGS. 9 to 10(B), a golf swing analysis apparatus 31 also includes, similarly to the golf swing analysis apparatus 1, a base plate 32, a pseudo human body 33 and a pseudo club 34.

The base plate 32 is made of a thin metal plate or a synthetic resin plate, and mounting holes 32a, 32a . . . are bored in four corner parts thereof so that the analysis apparatus 31 may be fixed at a predetermined part.

The pseudo human body 33 imitates a human body and includes a leg part 35, a body part 36 and an arm part 37. Further, an upper end of the leg part 35 and a lower end of the body part 36 are rotatably connected with a support shaft 38, and an upper end of the body part 36 and an upper end of the arm part 37 are rotatably connected with a support shaft 39.

The leg part 35 includes a lower leg part 40 formed with a rod-like member, and an upper leg part 41, and a foot part 42 formed with a plate-like member is connected to a lower end of the lower leg part 40. Further, mounting holes 42a, 42a are bored in the foot part 42 so as to be fixed to the base plate 32.

The body part 36 is formed with a cylinder 43, and a cylinder shaft 43b is slidable in a length direction of a cylinder rod 43a and rotatable around an axis of the cylinder rod 43a.

Accordingly, when the cylinder shaft 43b is slid and fixed at an appropriate position, a length of the body part 36 can be adjusted.

Further, when the cylinder shaft 43b is rotated, the arm part 37 can be rotated by an appropriate angle with respect to the body part 36.

In this manner, the rotating movement of the arm and the club using the body as the center axis of the swing can be realized.

Here, the arm part 37 can be regarded as the first virtual axis.

The arm part 37 is configured such that a left arm part 45 and a right arm part 46 are arranged at both sides of a cylinder 44, and a cylinder shaft 44b is slidable in a length direction of a cylinder rod 44a and rotatable around an axis of the cylinder rod 44a.

Accordingly, when the cylinder shaft 44b is slid and fixed at an appropriate position, a length of the arm part 37 can be adjusted.

Further, when the cylinder shaft 44b is rotated, a hand part 47 can be rotated by an appropriate angle with respect to the arm part 37.

In this manner, the rotating movement of the arm and the club considering the twisting movement of the body can be realized.

Further, the U-shaped hand part 47 is rotatably connected to a lower end of the cylinder shaft 44b by a support shaft 48.

In this manner, the cocking movement of the wrist with respect to the arm can be realized.

The pseudo club 34 imitates the club and includes a shaft part 49 and a head part 50.

The golf swing analysis apparatus 31 is configured as described above. It is possible to form a usable state by fixing the leg part 35 of the pseudo human body 33 to the base plate 32, setting the body part 36 at a predetermined angle with respect to the leg part 35, setting the arm part 37 at a predetermined angle with respect to the body part 36, and fixing the shaft part 49 of the pseudo club 34 to the arm part 37.

Here, if each length of the leg part, the body part and the arm part of the athlete or the enthusiast, as the subject, and the length of the club are measured, the pseudo human body 33 can be made to correspond to the subject by sliding the cylinder shaft 43b to be fixed at the appropriate position, adjusting the length of the body part 36, sliding the cylinder shaft 44b to be fixed at the appropriate position, and adjusting the length of the arm part 7.

The golf swing analysis apparatus 31 can also realize each state at every time point in the trajectory of the golf swing by rotating the arm part 37 by a predetermined angle having the body part 36 as the axial center.

Further, similarly to the golf swing analysis apparatus 1, it is possible to analyze the trajectory of the golf swing by setting the state at the time of address, the state at the time of backswing, the state at the time of topswing, the state at the time of downswing, the state at the time of impact, the state at the time of follow-through, the state at the time of finish, and the like, and photographing each state at every time point.

In addition, in the golf swing analysis apparatus 31, the leg part 35 includes the lower leg part 40 and the upper leg part 41, and the arm part 37 is configured such that the left arm part 45 and the right arm part 46 are arranged at the both sides of the cylinder. Accordingly, it is possible to analyze the trajectory of the golf swing which further approximates to an actual human body.

Next, further anther embodiment of the golf swing analysis apparatus according to the present invention will be described in detail with reference to the drawings.

FIG. 11 is a perspective view of further another embodiment of the golf swing analysis apparatus according to the present invention, FIG. 12(A) is a side view of the swing analysis apparatus and FIG. 12(B) is a front view thereof.

As illustrated in FIGS. 11 to 12(B), a golf swing analysis apparatus 51 also includes, similarly to the golf swing analysis apparatus 1, a base plate 52, a pseudo human body 53 and a pseudo club 54.

The base plate 52 is made of a thin metal plate or a synthetic resin plate, and mounting holes 52a, 52a . . . are bored in four corner parts thereof so that the analysis apparatus 51 may be fixed at a predetermined part.

The pseudo human body 53 imitates a human body and includes a leg part 55, a body part 56 and an arm part 57. Further, an upper end of the leg part 55 and a lower end of the body part 56 are rotatably connected with a support shaft 58, and an upper end of the body part 56 and an upper end of the arm part 57 are rotatably connected with a support shaft 59.

The leg part 55 includes a lower leg part 60 formed with a rod-like member, and an upper leg part 61, and a foot part 62 formed with a plate-like member is connected to a lower end of the lower leg part 60. Further, mounting holes 62a, 62a are bored in the foot part 62 so as to be fixed to the base plate 52.

The body part 56 is formed with a cylinder 63, and a cylinder shaft 63b is slidable in a length direction of a cylinder rod 63a and rotatable around an axis of the cylinder rod 63a.

Accordingly, when the cylinder shaft 63b is slid and fixed at an appropriate position, a length of the body part 56 can be adjusted.

Further, when the cylinder shaft 63b is rotated, the arm part 57 can be rotated by an appropriate angle with respect to the body part 56.

In this manner, the rotating movement of the arm and the club using the body as the center axis of the swing can be realized.

Here, the arm part 57 can be regarded as the first virtual axis.

The arm part 57 includes an upper arm part 64 and a forearm part 65, and the upper arm part 64 is rotatable about an axis thereof.

In this manner, the rotating movement of the arm and the club considering the twisting movement of the body can be realized.

Further, a U-shaped hand part 66 is rotatably connected to a lower end of the forearm part 65 by a support shaft 67.

In this manner, the cocking movement of the wrist with respect to the arm can be realized.

The pseudo club 54 imitates the club and includes a shaft part 68 and a head part 69.

A telescopic rod 70 is connected to a distal end of the upper arm part 64, and the head part 69 of the pseudo club 54 is fixed to a distal end of the telescopic rod 70.

Accordingly, when the telescopic rod 70 is extended or retracted to be set to an appropriate length, an angle between the arm part 57 and the pseudo club 54 can be adjusted.

Further, when the arm part 57 is rotated by an appropriate angle with respect to the body part 56, and further the hand part 66 is rotated by an appropriate angle while extending or retracting the telescopic rod 70, the movement of cocking the wrist while rotating the arm and the club can be realized.

Here, the telescopic rod 70 can be regarded as a second virtual axis which can be extended and retracted.

The golf swing analysis apparatus 51 is configured as described above. It is possible to form a usable state by fixing the leg part 55 of the pseudo human body 53 to the base plate 52, setting the body part 56 at a predetermined angle with respect to the leg part 55, setting the arm part 57 at a predetermined angle with respect to the body part 56, and fixing the shaft part 68 of the pseudo club 54 to the arm part 57.

Here, if each length of the leg part, the body part and the arm part of the athlete or the enthusiast, as the subject, and the length of the club are measured, the pseudo human body 53 can be made to correspond to the subject by sliding cylinder shaft 53b to be fixed at the appropriate position and adjusting the length of the body part 56.

Further, when the telescopic rod 70 is extended or retracted to be set to an appropriate length, the angle between the arm part 57 and the pseudo club 54 can be adjusted.

The golf swing analysis apparatus 51 can also realize each state at every time point in the trajectory of the golf swing by rotating the arm part 57 by a predetermined angle having the body part 56 as the axial center.

Further, similarly to the golf swing analysis apparatus 1, it is possible to analyze the trajectory of the golf swing by setting the state at the time of address, the state at the time of backswing, the state at the time of topswing, the state at the time of downswing, the state at the time of impact, the state at the time of follow-through, the state at the time of finish, and the like, and photographing each state at every time point.

In addition, in the golf swing analysis apparatus 51, the leg part 55 includes the lower leg part 60 and the upper leg part 61, the telescopic rod 70 is connected to the distal end of the upper arm part 64, and the head part 69 of the pseudo club 54 is fixed to the distal end of the telescopic rod 70. Accordingly, it is possible to analyze the trajectory of the golf swing which further approximates to an actual human body.

As described above, in the golf swing analysis apparatuses 1, 31 and 51 of the present invention, the left arm part and the right arm part are regarded as the first virtual axis which is integrated with one another. Accordingly, it is possible to perform analysis by simplifying each state during the golf swing.

In other words, it is possible to simplify complexity that a length of right and left upper limbs serving as a reference changes between a rear side and a front side of a target line at a boundary of the address or the impact by regarding a line from a swing center to a grip end of the club as the first virtual axis.

Further, the arm part as the first virtual axis is provided to be rotatable around the body part, and the golf club is provided to be rotatable in the hand part. Accordingly, it is possible to analyze the golf swing as a combination of the rotating movement of the first virtual axis and the cocking movement of the wrist.

According to the golf swing analysis apparatus of the present invention, it is possible to simplify and easily understand that the movement of an upper body is formed with four basic movements of two rotations and two hinges combining the two rotations including the twisting movement of a trunk part and the rotation (rotating movement) of the first virtual axis, and the two hinge movements including a hinge movement corresponding to a so-called “movement of striking a head in Japanese fencing (kendo)” of a curved part formed between the trunk part and the first virtual axis in the swing center part, and a hinge movement corresponding to the cocking of the grip part.

At the time of no-cocking, the hinge movements decrease by one so that it is simplified to two rotations and one hinge. In any case, it is possible to easily understand that the movement of the upper limb during the golf swing is the combination of the three to four basic movements.

Further, according to the golf swing analysis apparatus of the present invention, it is assumed and understood that a mechanism is present in which the second virtual axis is rotated (performs rotation) (also referred to as a “rotating movement in a V-shape) in a state (so-called a shape of the letter “Ku” in Japanese hiragana (a V-shape)) where a constant angle is formed between the virtual axis in the grip part and a club shaft, which is considered as one of important movements that accelerates the movement of the club head.

Further, it is assumed that such a mechanism is also present in other ball games in which a ball is flown far away, for example, baseball, tennis or the like.

In addition, since each angle of the leg part, the body part, and the arm part can be appropriately set, it is possible to realize a forward inclined posture corresponding to the subject to be analyzed and to perform the analysis of the golf swing close to the reality.

### REFERENCE SIGNS LIST

1 Golf Swing Analysis Apparatus
2 Base Plate
3 Pseudo Human Body
4 Pseudo Club
5 Leg Part
6 Body Part
7 Arm Part
10 Foot Part
11 Cylinder
12 Cylinder
13 Hand Part
31 Golf Swing Analysis Apparatus
32 Base Plate
33 Pseudo Human Body
34 Pseudo Club
35 Leg Part
36 Body Part
37 Arm Part
40 Lower Leg Part
41 Upper Leg Part
42 Foot Part
43 Cylinder
44 Cylinder
45 Left Arm Part
46 Right Arm Part
47 Hand Part
51 Golf Swing Analysis Apparatus
52 Base Plate
53 Pseudo Human Body
54 Pseudo Club
55 Leg Part
56 Body Part
57 Arm Part
60 Lower Leg Part
61 Upper Leg Part
62 Foot Part
63 Cylinder
64 Upper Arm Part
65 Forearm Part
66 Hand Part
70 Telescopic Rod

1. A golf swing analysis apparatus comprising:
a pseudo human body including a leg part, a body part and an arm part; and
a pseudo club.

2. The golf swing analysis apparatus according to claim 1, wherein the leg part is fixed to a base plate.

3. The golf swing analysis apparatus according to claim 1, wherein an upper end of the leg part and a lower end of the body part are rotatably connected, and an upper end of the body part and an upper end of the arm are rotatably connected.

4. The golf swing analysis apparatus according to claim 1, wherein each of the body part and the arm part is formed with a cylinder so as to enable length of each to be adjusted.

5. The golf swing analysis apparatus according to claim 1, wherein the body part is formed with a cylinder so as to enable a length thereof to be adjusted, and the arm part and the pseudo club are connected with a telescopic rod so as to enable an angle between the arm part and the pseudo club to be adjusted.

6. The golf swing analysis apparatus according to claim 1, wherein the leg part further includes a lower leg part and an upper leg part.
